(19) United States
(12) Patent Application Publication
(10) Pub. No.: US 2003/0180132 A1
(43) Pub. Date: Sep. 25, 2003

(54) Mobile lift

(76) Inventor: Steven Morreim, Belvidere, IL (US)

Correspondence Address: KEITH FRANTZ, 401 WEST STATE STREET, SUITE 200, ROCKFORD, IL, 61101

(21) Appl. No.: 10/367,468

(22) Filed: Feb. 14, 2003

Related U.S. Application Data
(60) Provisional application No. 60/357,603, filed on Feb. 14, 2002.

(51) Int. Cl. B66C 5/02

(52) U.S. Cl. 414/458

(57) ABSTRACT

A mobile lift is adapted for adjustment of its width, length and height for increased utility in transporting loads.

### CROSS-REFERENCES TO RELATED APPLICATIONS

This application claims priority benefit to U.S. Provisional Patent Application Serial No. 60/357,603, filed Feb. 14, 2002.

REFERENCE TO MICROFICHE APPENDIX

N/A.

STATEMENT REGARDING FEDERALLY SPONSORED RESEARCH OR DEVELOPMENT

N/A.

### BACKGROUND OF THE INVENTION

1. Field of Invention

This invention relates to generally to lifts, more specifically, to a mobile lift which, while suitable for many uses, is particularly adapted for heavy loads and moving the loads from place to place.

2. Description of Prior Art

There are a multitude of known lift arrangements for moving heavy loads. However, such prior lifts are generally of limited adjustability with regard to the size and shape of the type of load it can lift, or they are limited to use on rails, or on paved streets and parking lots.

Accordingly, there is a need for a new mobile lift that addresses the drawbacks of prior lifts, and is adapted for increased utility with regard to load carrying and transporting capability.

### SUMMARY OF THE INVENTION

A mobile, self-powered, fully self-contained lift includes several unique characteristics.

The lift of the present invention is uniquely adapted for both manual and powered adjustment of its width, length and height (accordingly, referred to hereinafter as the 3D lift). Powered adjustment of the 3D lift can be accomplished electrically, mechanically, hydraulically, pneumatically, or otherwise.

The 3D lift is further uniquely characterized with a slip-together construction that provides for ease of assembly and disassembly. Such arrangement and capability permits, for example, transport of a disassembled lift on an airplane, and reassembly at a remote site. Additional aspects of the present invention are discussed and/or will become evident in view of the disclosure herein.

The general purpose of the 3D lift is to provide an easily portable, changeable, and dependable lift with the ability to be moved down the road, either within the legal physical constraints for road transportation, or with a wide-load status for larger sizes, and then widen out, lengthened, and/or raised to handle, lift, position and move a load as needed.

The 3D lift can be used to supply a lift in warehouses with or without overhead cranes because it can move long or bulky assemblies from one bay to another, it can also move to outside areas and do many jobs including load and unload trucks. It is unique in the ability to move a large assembly through a door, where the interior overhead height is limited, and then raise the assembly and load it onto a truck, or unload a truck outside and bring the lowered assembly inside. Larger sizes can be used to pick up and load containers, trucks, heavy equipment, military tanks, and armored vehicles. With a remote control unit, the lift can be used to safely handle hazardous material, explosives, and military ammunition. Current 3D lift models planned have a lifting ability of from 12,000 pounds (or less) up to 250,000 pounds (or more if needed).

The 3D lift can be transported on a truck/tractor by moving around the wheels then narrowing itself to then be locked into the truck frame for fast moving down the road. It can also have a towing package with a removable hitch or fifth wheel so it can be pulled behind a truck or vehicle. The 3D lift can be used to supply a movable truck-unloading ramp for forklifts and even a fast container unload roller system. It could be used to move ammunition in and out of LST (Landing Ship Transport) ships at a fast rate because of larger load carrying capabilities. It can be used in remote locations for unloading containers, raising airplanes for fixing undercarriage and be completely field ready. The 3D lift can be operated by on-machine controls or by remote control. The slip together construction facilitates adjustability in three dimensions, and allows for disassembly and shipping in containers, and even on large military type aircraft for remote military operations. In the raised position, an upper gun turret can be used for remote operation of rockets, flame-throwers, and other military hardware, and to see over hills with telescoping cameras. In short, the 3D lift is capable of being adapted to many uses and changing needs.

### BRIEF DESCRIPTION OF THE DRAWINGS

FIG. 1 (and FIG. 1A) is a perspective view of a new lift incorporating the unique aspects of the present invention.

FIG. 2 (and FIG. 2A) is a perspective view of the lift of FIG. 1 but showing the lift in a raised position.

FIG. 3 (and FIG. 3A) is a fragmentary perspective view showing a multi-stage vertical frame structure.

FIG. 4 (and FIG. 4A) is a perspective view similar to FIG. 1 but showing alternate wheel and short-track options.

FIG. 5 (and FIG. 5A) is a top plan view of the 3D lift forks that may be used on FIG. 6 on both front corners.

FIG. 6 (and FIG. 4A) is a perspective view of an alternate embodiment lift in accordance with the invention, including front forks for use as a forklift such as useful in lifting and moving palletized loads

FIG. 7 is a perspective view of a second alternate embodiment lift in accordance with the invention, including a portable truck dock such as useful for loading and unloading a truck with a forklift, both in the field and at a job site.

FIG. 8 is an enlarged top plan view of certain steering components at the front end of a lift in accordance with the invention, and showing wheel positions during normal travel in solid lines and toe in-toe out travel shown in dashed lines.

FIG. 9 is a schematic representation of a hydraulic fluid circuit suitable for use in a lift of the present invention.

FIG. 10 is a view of a rotary crane and associated control station mounted to the top of the lift in accordance with the invention.

FIG. 11 (and FIG. 4A) is a perspective view of a third alternate embodiment lift in accordance with the invention, including a side mounted platform connected to be raised and lowered with the upper frame of the lift.

FIGS. 12A and 12B are end and top views of lift and a load.

Reference numerals in the drawings correspond to the following items:

10—3D lift

12—frame

12a—load lift apparatus

12b—load

14—operator's station

16—upper frame structure

18—horizontal upper-side telescoping frame sets

18a—outer, end upper-side telescoping frame members

18b—center, inner upper-side telescoping frame members

18′—second stage horizontal telescoping frame sets

20—horizontal cross-frame telescoping sets

20a—outer, end cross-frame telescoping members

20b—center, inner cross-frame telescoping members

22—vertical telescoping frame sets (lift frame sets)

22a—stationary vertical frame members

22b—inner movable frame members

22c—movable vertical frame members

22d—upper outer movable frame members

22′—multi-stage vertical telescoping frame sets

24—horizontal lower-side telescoping frame sets

24a—outer, end lower-side telescoping frame members

24b—inner, center lower-side telescoping frame members

26—bolts

28—aligned through holes in associated frame sets

30—second stage vertical telescoping frame sets

30a—second stage inner, movable vertical frame members

32—wheel sets

34—short tracks

36—alternate wheel sets

38—hydraulic power unit

40—hydraulic fluid reservoir

42—hydraulic motors

44—hydraulic lines

46—lift hydraulic cylinders

48—length adjusting hydraulic cylinders

50—width adjusting hydraulic cylinders

52—steering hydraulic cylinder

54—steering hydraulic cylinder

56—steering connecting plates

58—vertical steering torque-transfer rods

60—engine

62—wheel drive

64—forks

66—portable truck dock

68—top crane

70—rotating platform

72—side platform

74—lift stabilizer pads

### DETAILED DESCRIPTION OF THE INVENTION

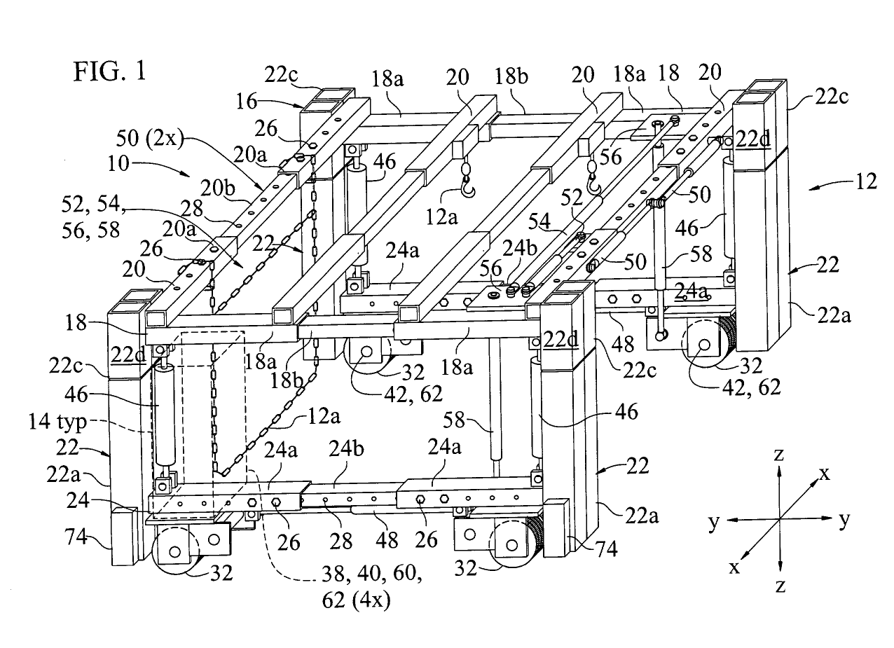

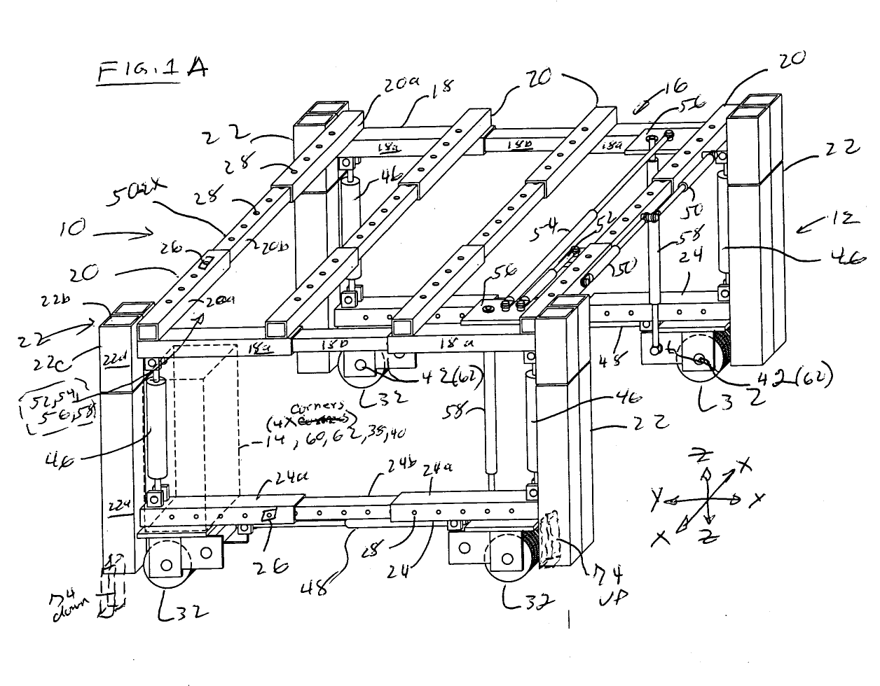

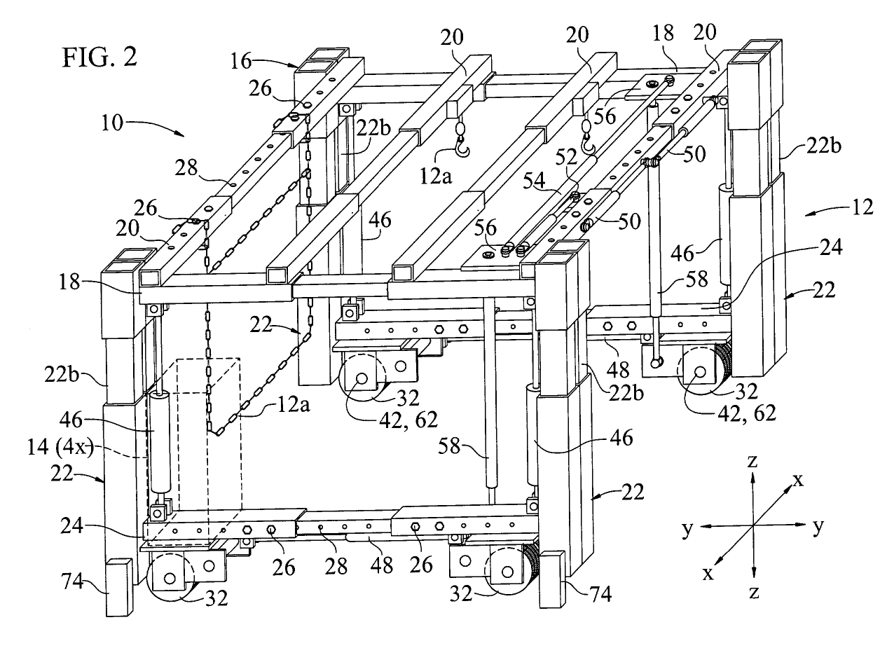

For purposes of illustration, one embodiment of the present invention is shown in the drawings as 3D lift 10 in a lowered position in FIG. 1 and in a raised position in FIG. 2.

For simplicity of illustration, multiple instances of various ones of the components of the 3D lift 10 are not shown in the drawings. Instead, such components may be shown once or twice in the drawings, with a note herein indicating such multiple instances, or as would conventionally accepted in view of the disclosure hereof.

Briefly, the 3D lift 10 includes: frame 12 that is adjustable in width, height and length; article lift apparatus connected to, and typically raised and lowered with, the frame for connecting to or around the article or load to be lifted and carried; controlled rolling support, such as provided with powered wheels or a track system, for rolling mobility of the lift; a power supply system adapted to provide all power needs of the lift, and to optionally provide an external power supply such as would be useful at remote field locations; a power conversion system operatively connected between the power supply, the frame and controlled rolling support, to accomplish powered adjustment and control of the frame and movement of the lift; and an operator's station 14 indicated generally in dashed lined in FIG. 1, and provided with manually operable controls (not shown) for control of the various operative functions of the lift.

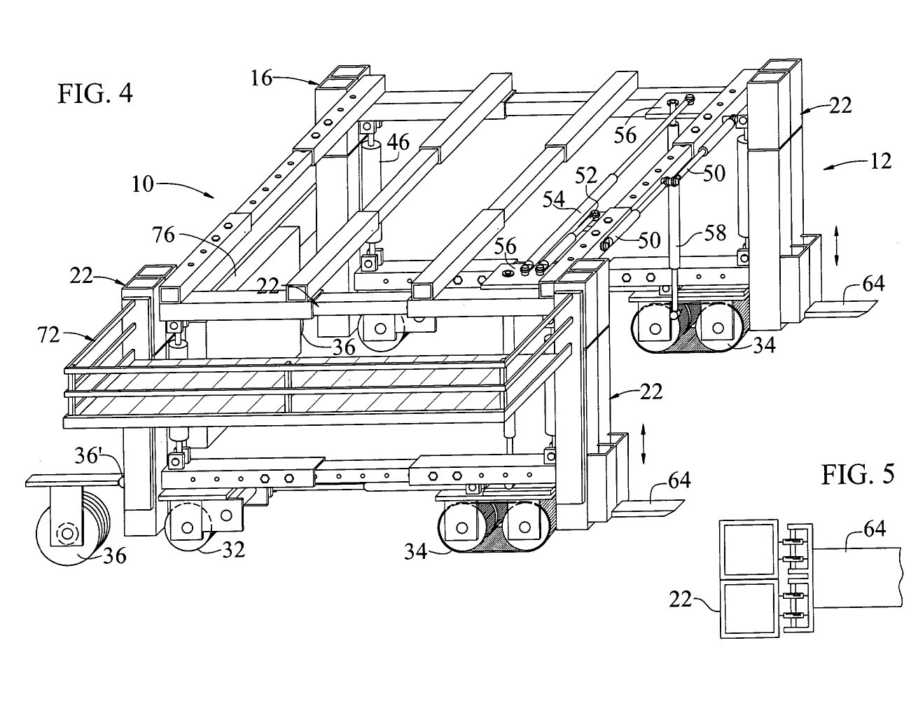

The frame 12 is generally cubic in structure, with an open bottom and open front and sides to drive over and bridge over a load to be transported, and is adapted for adjustment in width, length and height, designated as “X”, “Y” and “Z” respectively, in FIG. 4. In general, the frame 12 consists of sets of telescoping structural frame sets that provide adjustability in 3 dimensions. The cross-sectional size and wall thickness of the various frame members are sized for the required load demands.

More particularly, the frame 12 includes:

a generally rectangular upper frame structure 16 for positioning above the load that raises and lowers for lift height adjustment during operation of the lift; the upper frame 16 includes:

a pair of horizontal, upper-side telescoping frame sets 18,

each frame set 18 comprising outer frame members 18a at each end thereof and a center frame member 18b telescopically received in the end members 18a, and

horizontal, telescoping cross-frame (laterally extending) sets 20,

each cross-frame set 20 comprising outer frame members 20a at each end thereof and a center frame member 20b telescopically received in the end members 20a;

the end frame members 18b and a pair of front-to-back spaced end members 20b of the cross-frame sets being connected together to establish a generally rigid, yet adjustable, upper frame structure;

in embodiments, as shown, in which more than two cross-frame sets 20 are provided, the outer ends 20a of the additional cross-frame sets are also connected to the outer ends 18a of the side frame sets 18;

32 at least four sets of vertical telescoping frame sets 22, with one connected in supporting position near each of the four corners of the generally rectangular footprint of the upper frame and lift as in the embodiment shown,

each vertical frame set 22 includes a vertical stationary member 22a (the outer member shown) and a vertical movable member including an inner member 22b shown slidably positioned in the outer member 22a;

a set of horizontal, lower-side telescoping frame sets 24 connected between the pairs of stationary vertical frame members 22a on each side such that the height of the lower-side frame sets is fixed during operation of the lift; and

apparatus to secure the upper side, lower side and cross-frame telescoping sets in telescopically fixed position after being adjusted as desired.

In the embodiment shown, each of the outer and inner frame members of each telescoping frame set are provided with through holes (generally indicated by reference numeral 28 in the drawings) that are alignable with the members in alternate telescoped positions therebetween. In this instance, the associated frame members are secured into fixed relation after adjustment with threaded bolts 26 slidably inserted through the aligned holes 28, and secured therein with threaded nuts (not shown) tightened on the free ends thereof.

Alternate arrangements for selectively releasing and securing the telescoping frame members in fixed relation to one another are well known, or will be readily devised by those skilled in the art.

The embodiment shown in FIGS. 1 and 2 is a single-stage structure, in which each vertical frame set 22 includes the vertical stationary member 22a, and a vertical movable member 22c including the inner member 22b slidably positioned in the outer member 22a and an upper portion 22d connected to the upper portion of the inner member 22b and the upper frame 16.

In alternate embodiments (not shown), vertical telescoping frame sets are provided with, for example, inner stationary frame members and outer frame members telescopically positioned therearound for raising and lowering the upper frame.

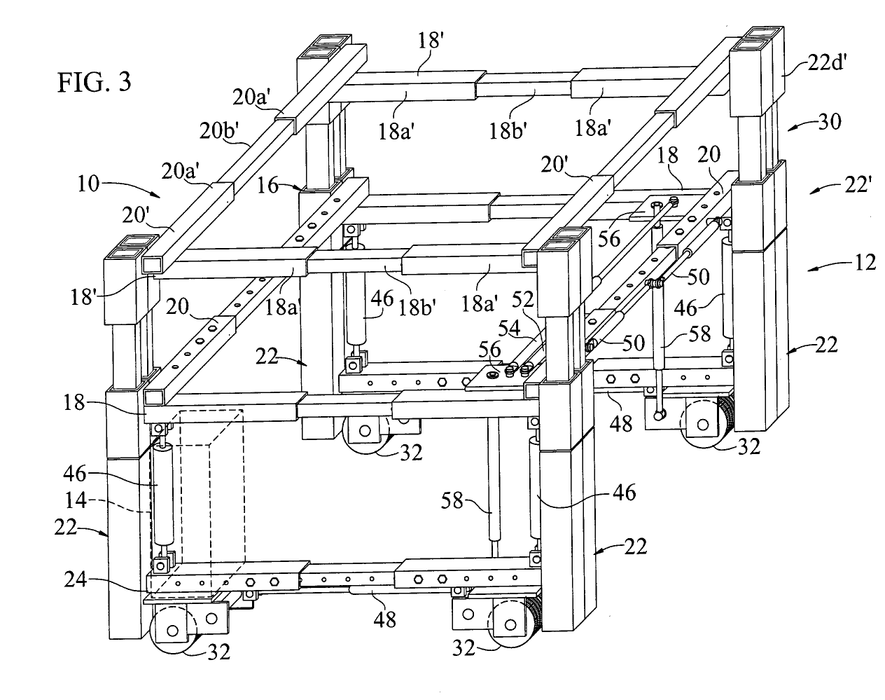

In additional alternate embodiments, the vertical telescoping frame structure is provided as a multi-stage structure, such as generally shown in the two-stage lift in FIG. 3, wherein the telescoping frame sets 22′ are provided in multiple stages in the “Z” direction, with each stage set to provide a given height adjustment or stroke, to achieve enhanced height adjustment as compared with a single stage of a given height.

In this instance, each telescoping frame set 22′ includes a lower stage 22 and an upper stage 30 that is provided with an inner, vertically movable frame member 30a slidably positioned inside the inner, movable member 22b. The lift also includes additional lift rams (not shown) connected between the lower side frame sets 24 and the upper side frame sets (such as sets 18 and 18′ shown in FIG. 3) for independent lift capability thereof.

Two, three, four or more stage telescoping corners and lift rams may be used.

Advantageously, multi-stage lifts provide for additional vertical lift capability, while utilizing many common components as a single stage lift.

The embodiments shown include two vertical telescoping frame sets 22 at each corner for purposes of illustrating that multiple sets may be provided such as for increased lift capability with a given frame size. As will be evident, multiple frame sets, or a number of frame sets different from the number shown, may also be utilized in the side frame sets 18 and 24, and the cross-frame sets 20.

As shown, in preferred embodiments, the side telescoping frame sets 18 and 24, and the cross-frame sets 20 are configured each with a pair of spaced outer, end members that are connected as required hereof, and an inner, center member that is slidably received into the associate outer frame members. This arrangement provides for improved stress distribution, such as opposed to providing a single outer and single inner member for each telescoping frame set.

The center members 18b, 20b, 22b and 24b of the telescoping frame sets can be changed (i.e., the center members can be changed to center members of a different length) to enable increasing and decreasing the associated adjustably as desired. Advantageously, the ability to slide in different center members enables changing of adjustability in the field if desired. This arrangement also permits providing lifts of various adjustability from manufacture with identical components except with inner frame members of different lengths.

Article lift apparatus is provided in any form as desired for purposes of lifting the desired object(s). The lift apparatus is typically operative from the upper frame, to enable lifting of the article either therefrom, and/or as the frame is raised. Examples of suitable lift apparatus include, but are not limited to: Chain, cables, hooks and ropes extending around, hanging from, or otherwise connected to the upper frame 16 and adapted for connection to or around at least portions of the article to be lifted—such that raising the upper frame lifts the article. A powered hook and cable lift, hanging from the upper frame, and adapted to connect to and raise the load while maintaining the upper frame stationary. Article lift apparatus may also be of a type that both lifts the load and moves the load independently of the frame. One suitable arrangement is a hydraulic/wire rope “trolley” crane (traversing hook) system connected to the upper frame of the lift. These and other suitable lift arrangement are known, and will be readily devised by those skilled in the art.

The controlled rolling support includes:

one, two or four wheels located at each corner of the frame, or alternately, for example, a power-controlled short-track located at each corner of the frame, or a large track on each side for very rough terrain;

power drive apparatus suitable for the type and number of wheels or track system used, such as a two, four or more wheel drive system, or dual or quad track drive system;

a braking or speed reduction system (not shown) suitable for the wheels or track system thereof; and

suitable, manually operable controls (not shown) located at the operator's station 14, the controls being operable connected to the power drive, wheels and brake or speed control apparatus for control thereof.

The number and type of wheels and/or the number and size of tracks are provided suitable for the desired weight carrying capability, and for intended operational duty (e.g., anticipated terrain) of the lift. For example, solid forklift-type wheels are generally preferred for heavy-duty load-carrying capability on paved landscape. Other suitable wheels include, but are not limited to, more conventional truck or aircraft-type inflated wheels. Alternately, for example, track systems are designed for durability in rough terrain.

Power drive apparatus is adapted for the type and number of wheels or track system used, and may include, but not limited to: synchronized or independently operable hydraulic motors, and synchronized or independently operable electric motors. In preferred embodiments, the wheel motors or drive train are adapted for operation both synchronized and independently. Normal movement or travel of the lift utilizes synchronized operation, whereas independent operation enables powered adjustment of the size of the lift (discussed further below), and enables multi-drive capability for rough terrain. Wheel position control, and the steering arrangement of the 3D lift 10 are discussed further below.

For simplicity of illustration, the drawings show a single wheel set in at least one corner. However, it will be understood that such selected wheel sets or track system will be provided in all four locations as required to provide stable rolling support and driveability of the lift. A dual-wheel set 32 is shown in FIGS. 1 and 2 in connection with the corners of 3D lift 10. Alternate four powered short tracks 34 are provided for rough terrain, or long tracks extending along the sides from front to back, and alternate positioned and sized wheel sets 36 are shown in FIG. 4.

Power conversion is provided as generally electrical, mechanical, pneumatic or hydraulic in nature, or a combination thereof, and includes the various components as required to accomplish the desired effect. In the embodiment shown, a hydraulic system generally provides for powered adjustment of the frame 12 and movement of the lift. The hydraulic system shown includes: a hydraulic power unit 38, hydraulic fluid reservoir 40, hydraulic motors 42 for powered rotation of the wheels 32, hydraulic cylinders for movement of the frame and steering of the wheels, hydraulic manifold, valves, and related distribution and control components as required for the system specified, hydraulic controls at the operator's station 14, and hydraulic connections therebetween as operatively required.

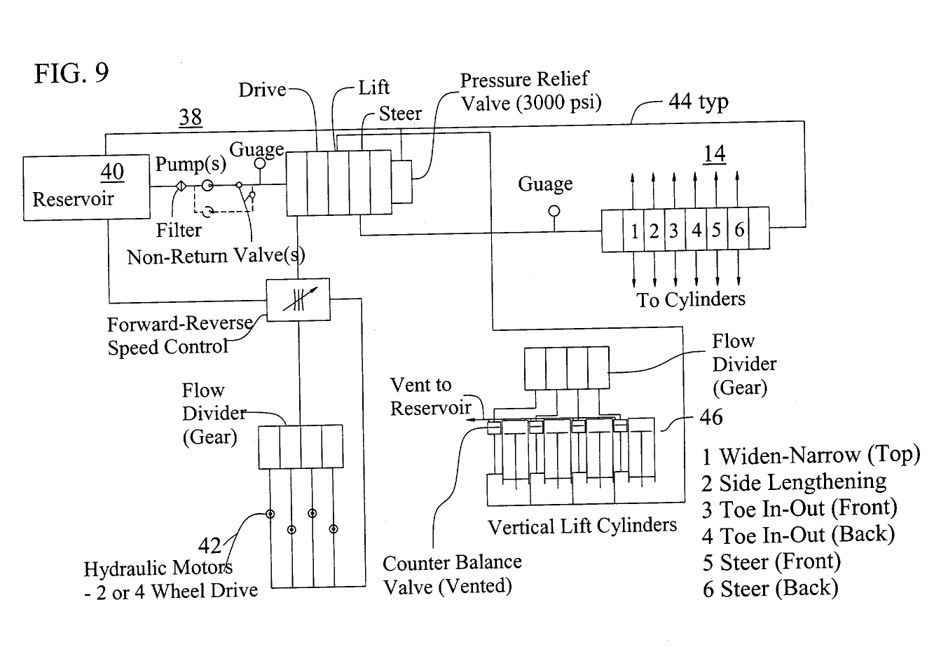

A suitable hydraulic circuit, with various hydraulic and related components, is shown in FIG. 9. Hydraulic communication between the various components is established via hoses (generally indicated as lines 44 in FIG. 9) that are located and restricted to avoid potential interference with operation of the lift and with the article to be lifted. In preferred embodiments, where possible, the hoses are positioned located above the upper frame 16.

The hydraulic cylinders shown include: lift (height adjusting) rams 46 associated with each of the four corner sets of vertical telescoping frame sets 22, and connected in each corner between the lower side telescoping frame members 24a and the upper frame members 18a; length adjusting rams 48 connected between the telescoping members 24a of each of the lower side frame sets 24; width adjusting rams 50 connected between the outer telescoping members 20a of one cross-frame sets; and steering rams 52, 54 connected for wheel position control.

Hydraulic cylinders 50 insure that the inner cross-frame members 20b remain laterally centered in the outer cross-frame members 20a during width adjustment. The casing end of the cylinders are connected the associated outer frame members 20a, and the piston rods are connected to each in the center thereof. Suitable electromechanical, pneumatic, and other components may be alternately used to effect the desired power conversion purposes hereof.

Steering of the 3D lift 10 shown is provided for with a hydraulic cylinder linkage steering arrangement. As seen in FIGS. 1 and 8, the steering arrangement includes: a pair of connecting plates 56, one plate associated with each of the wheel sets 32 in the front corners of the lift; cylinder 52 connected between one connecting plate 56 and a fixed portion of the upper frame such as the front end member 20a on the side thereof; cylinder 54 spanning the width of the lift and connected between the connecting plates 56; a pair of vertical torque-transfer rods 58 extending downwardly from connecting plates, from a position rearwardly of the cylinder 54 connections, to the associated wheel sets 32 in each of the front corners.

The cylinders 52 and 54 are hydraulically connected for extension and retraction independently of one another. In particular, referring to FIG. 9, it will be seen that extension and retraction of cylinder 52, while maintaining cylinder 54 at a constant length, results is synchronized turning of the wheels on both sides of the lift. For example, extension of cylinder 52 causes the wheels to turn clockwise with the same angle of rotation, and retraction of the cylinder 52 causes the wheels to both turn clockwise with the same angle of rotation. Alternately, if the spanning cylinder 54 is adjusted while changing the extended length of cylinder 52, the wheels can be turned independently of one another. For example, if both cylinders 52, 54 are retracted, both wheel sets 32 will turn inwardly, and if both cylinders are extended, both wheel sets will turn outwardly, as shown in FIG. 8 in dashed lines.

In certain embodiments, both ends of the lift are provided with independently steerable wheels as described. This allows, for example, sideways travel or adjustability in turning such as may be desirable in moving relatively long loads into or through restricted areas, and for sideways or crab-like positioning of the load.

The power supply may be provided in any suitable form, such as, but not limited to, one or more engines (e.g., LP, gasoline, diesel, hydrogen, storage batteries), or another power supply, adapted to supply all power needs to the lift for self-contained operation, such as to drive the hydraulic pump for power to the hydraulic lift and control system, and to power an electric generator if electric motors are used. The lift may also include a prime mover suitable for independent “down the road” operation.

In the embodiment shown, the hydraulic power unit 38 and certain associated hydraulic components, the hydraulic reservoir 40, the fuel tanks 60, the power engine 62, and related components, generally represented as the operator's station 14, are generally positioned in the four corners of the frame 12 such as generally indicated in dashed lines FIG. 1. Advantageously, this provides for the shortest lift profile, while enabling configuration of the lift for maximum height adjustability for a given frame height size. Alternately, such components may be positioned as desired for specific alternate designs. By way of example, in instances where a height limitation is not critical, the hydraulic power unit, the reservoir, the engine and the fuel tanks may be located on the top of the frame 16, and the operator's station to the side of the frame.

The length of the lift 10 can be adjusted both manually and via powered-mode. Prior to length adjustment, the bolts 26 in the upper and lower side frame sets 18, 24 are removed. The length of the lift is then adjusted by moving the front and back of the lift towards or away from one another, causing the center members 18b, 24b to be further received into or extended from the end members 18a, 24a until desired holes 28 align therebetween, and the bolts reinstalled and tightened into the newly aligned holes 28 in the center and end frame members. The length of the lift can be adjusted by either manually moving the front and back in relation to each other, or powered by the drive wheels, such as by blocking the non-driven wheels in a two-wheel drive lift, or alternately by extending and retracting the hydraulic cylinder 48 with the wheels in a free-rotation mode. With four-wheel (or quad-track) drive, the length of the lift can also be power-adjusted by driving, for example, the front wheels while braking the back wheels.

The width of the lift 10 can be adjusted both manually and via powered-mode. Prior to width adjustment, the bolts 26 in the cross-frame telescoping sets 20 are removed. The width of the lift is then adjusted by moving the sides of the lift towards or away from one another, causing the center members 20b to be further received into or extended from the end members 20a until desired holes 28 align therebetween, and the bolts reinstalled and tightened into newly aligned holes 28 in the center and end cross-frame members. For manual adjustment, the wheels are simply turned to angle sideways, and one side is pushed towards or away from the other side.

Powered adjustment of the width of the lift is accomplished via operating the wheels with a crab-like movement. To power-reduce the width of the lift, the operator turns the front wheels inwardly, toward one another (toe-in), and then powers the lift forward. As the wheels roll forwardly, they also roll toward one anther, reducing the width of the lift. Similarly, to power-increase the width of the lift, the front wheels are turned outwardly, away from one another (toe-out) as shown in dashed lines in FIG. 8, and are powered with forward rotation to drive the sides of the lift away from one another. In either instance, when the desired width is reached, forward rotation of the wheels is stopped, and the bolts are replaced in the cross-frame sets 20. During such powered width adjustment, the cylinders 50 are simultaneously extended or retracted to keep the center frame members 20b centered with respect to the end frame members 20a.

Once the size (length and width) of the lift is established, the load is connected to the lift with article lift apparatus, examples of which are discussed both above and below. Such connections may be made either manually or automatically by the operator at the operator's station 14.

The upper frame 16 is raised and lowered by the operator at the operator's station 14, by manual adjustment of the hydraulic controls to the lift rams 46. In particular, the operator raises and lowers the upper frame by causing the lift rams 46 to extend and retract. With the load firmly carried by the upper frame, the load raises and lowers therewith. Multi-stage lifts include controls suitable for the multi-stage lift rams. Alternately, the load may be raised and lowered with suitable article lift apparatus while maintaining the upper frame 16 at a constant height.

The wheel drive 62 is adapted to power the wheels in both forward and reverse directions. With the load firmly carried by or connected to the lift, the load can than be moved to a desired location for unloading, by simply powering the wheels forward, and steering as required. Advantageously, the height of the lift can be changed as required while carrying the load, such as to clear under a doorway or raise the load for positioning onto a train car or trailer.

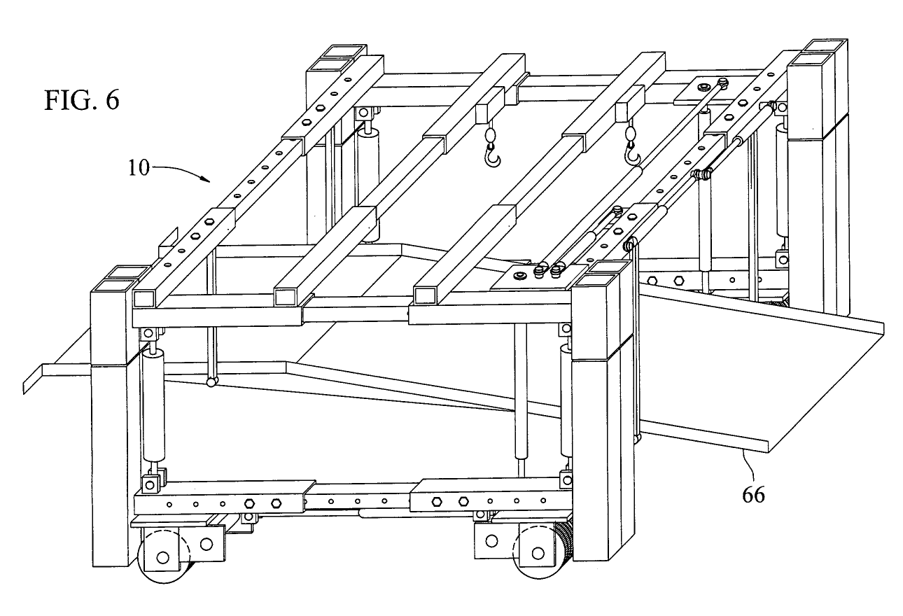

In alternate arrangements and embodiments, the lift includes, as shown in FIG. 5, a top view of one typical fork 64 with roller/tracks for lifting and lowering a load. As shown in FIG. 6, a large forklift type front, with laterally spaced forks 64, can be connected for raising and lowering with the upper frame 16 to lift and carry palletized or stacked loads, or other articles provided with fork-receiving cavities such as containers from the side. A counter weight is added as needed for heavy lifts.

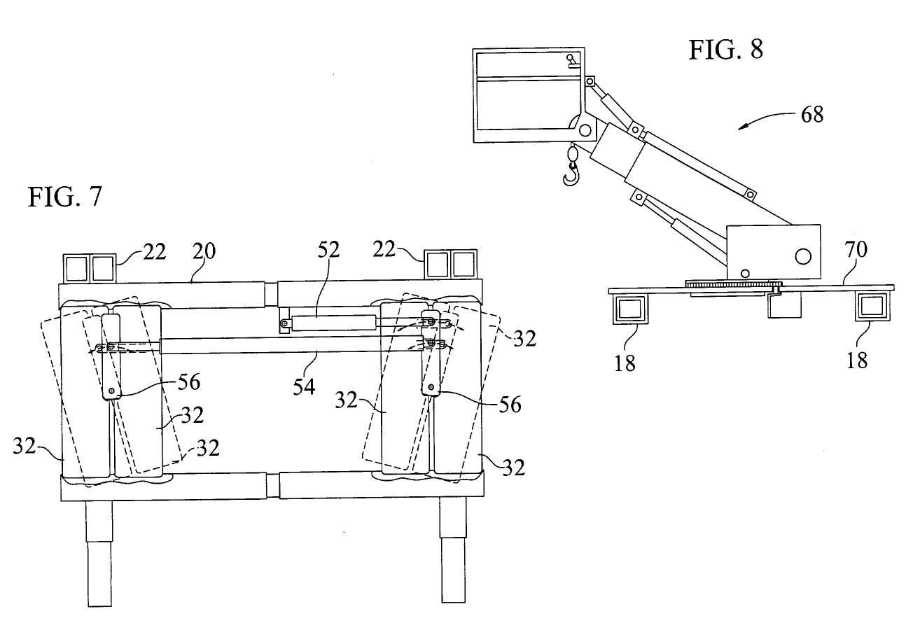

As shown in FIG. 7, the lift can carry a portable truck dock 66, to enable loading and unloading of a truck with a forklift, both at a job site and in the field.

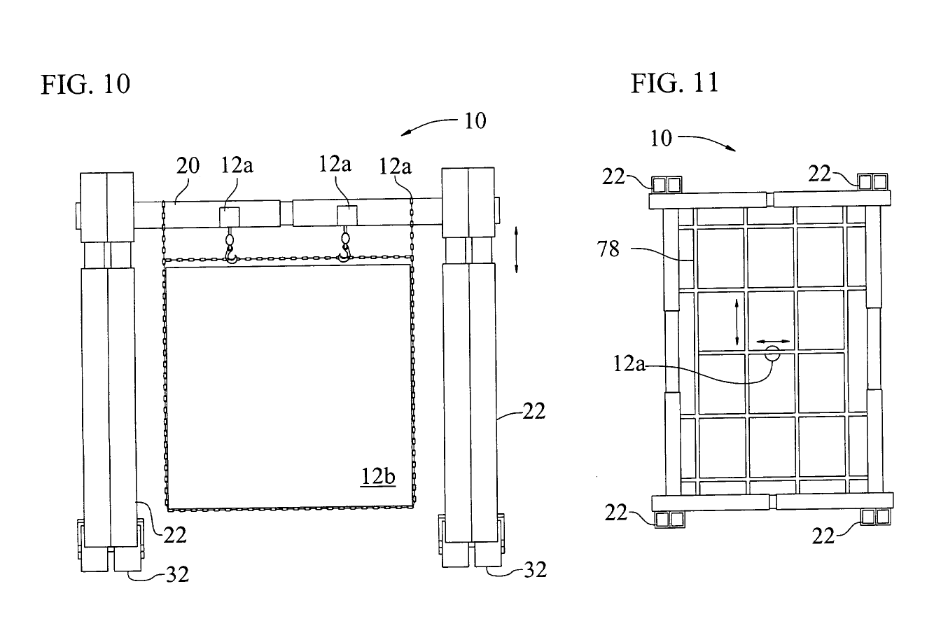

As shown in FIG. 10, a top crane 68 or rotating platform 70 positioned on the top of the lift, or a mechanical lift or basket such as suitable for use in construction of buildings and inventory placement.

As shown in FIG. 11, a side mounted and optionally movable platform 72 attached to the top sides of the lift for raising and lowering therewith, such as suitable for use in building construction and laying bricks or concrete blocks.

For independent down-the-road operation, the lift is provided with suitable prime mover, wheels, steering control and brakes. Alternately, a down-the-road free wheeling set of inflated tires could be used for high speed pulling of the lift such as by a semi-tractor, such as indicated by wheels 36 pivotable into and out of position as sohwn. This requires a one-end steering, and tongue hitch pulling arrangement. An outside mounted system could also operate the drive wheels or tracks with a leveling system for rough terrain that would keep the 3D lift and load level.

For increased container handling capability, the center of the frame can be left open, with more length added to stack one container above another when an extra third stage is added. One end of the lift could also be separately lifted to clear the container.

A fixed or movable, top or end platform such as suitable for building construction and maintenance, to facilitate activities such as installing and replacing overhead or hard to reach lights. Bottom stabilizer leveling pads 74 such as typical on a track crane for lifting loads heavier than the wheels will handle. In this instance, a truck would back under the lift for load-out of the object being lifted therefrom. The stabilizer pads with hydraulic rams would be on the four corners, either inside or outside the lifting slides, depending on which wheel package is used. A raised motor and hydraulic pump for fording streams allowing for bridge building, moving vehicles or military tanks across rivers such as up to 11 feet deep or more. Hydraulic rams on the side frame to hook up chain or slings, used as load levelers or tighteners, such as particularly useful in carrying long loads (i.e., loads whose length substantially exceeds the length of the lift). Exterior weather covers for rain and other climate protection. Safety equipment and lock mechanisms, for increased load-holding safety, such as particularly useful if working under a raised load.

I claim:

1. A mobile lift comprising:
a generally rectangular, horizontal frame structure including (i) first and second laterally spaced telescoping side frame members, and (ii) front and back telescoping cross-frame members operatively connected between the side frame members for adjustability of the frame structure in length from front to back and in width from side to side;
front and back pairs of vertical telescoping frame members supporting the horizontal frame structure proximate the front and back corners respectively for adjustability of the height of the horizontal frame structure;
article lift apparatus connected in fixed relation to one of said frame structure and said vertical frame members, and adapted to engage a load for raising and lowering a load from the ground;
a pair of laterally spaced telescoping horizontal frame members connecting the front and back vertical frame members on each side of the frame structure for adjustability between said front and back pairs associated with adjustability the side frame members of said frame structure;
front and back rolling supports proximate the front and back corners of the lift and supporting the frame members and frame structure for ground mobility;
one of a speed reduction system and a braking system connected to said rolling supports; and
a steering mechanism for at least one of said front rolling supports and said back rolling supports.

2. The mobile lift as defined in claim 1 in which said rolling supports comprise one of
(i) a pair of front wheels and a pair of back wheels in supporting relation with the four corners of the frame structure,
(ii) a pair of front rolling track mechanisms and a pair of back rolling track mechanisms in supporting relation with the four corners of the frame structure, and
(iii) a pair of laterally spaced rolling track mechanisms in supporting relation with and extending generally from front to back under the sides of the frame structure.

3. The mobile lift as defined in claim 1 in which said rolling supports includes multiple pairs of front wheels and multiple pairs of back wheels in supporting relation with the four corners of the frame structure.

4. The mobile lift as defined in claim 1 further comprising a power drive connected to at least one of the front and the back rolling supports for powered forward and backward driving and steering of the lift.

5. The mobile lift as defined in claim 4 in which said power drive is connected for at lest one of (i) synchronized and (ii) independent operation of said one of the front and back rolling supports.

6. The mobile lift as defined in claim 4 in which said power drive is connected for both synchronized and independent operation of said rolling support means.

7. The mobile lift as defined in claim 4 in which said power drive comprises at least one of (i) a hydraulic drive circuit, (ii) a pneumatic drive circuit, (iii) a mechanical drive circuit, and (iv) an electrical drive circuit.

8. The mobile lift as defined in claim 4 in which said power drive comprises independently operable motors connected to said rolling supports, said motors being one of hydraulically, electrically or pneumatically powered.

9. The mobile lift as defined in claim 1 in which said rolling supports and said steering and said one of said speed reduction and braking systems are street-suitable, said lift further comprises a street-suitable prime mover for powering the unit along the street.

10. The mobile lift as defined in claim 1 further comprising a free-wheeling set of street-suitable tires, and a hitch mechanism for connection to a powered towing vehicle.

11. The mobile lift as defined in claim 1 further comprising an automatic leveling system connected between the rolling supports and the frame structure and adapted to maintain the lift and its load in a generally level condition for use on uneven terrain.

12. The mobile lift as defined in claim 1 further comprising an operator station provided with operational controls for the lift and connected to one of the frame structure, the vertical frame members and the horizontal frame members.

13. The mobile lift as defined in claim 12 in which the operator station is connected to the frame structure for raising and lowering therewith.

14. The mobile lift as defined in claim 1 in which said steering mechanism includes actuation and control linkage located in a generally overhead position connected to said frame structure.

15. The mobile lift as defined in claim 14 in which said actuation linkage includes a pair of laterally spaced overhead connecting plates, a first actuator connected between one of said connecting plate and said frame structure, a second actuator spanning across the width of the frame structure and connected between the connecting plates, the first and second actuators being independently operable from one another, and a pair of vertical torque transfer tubes pivotally connected between the connecting plates at a location behind said actuators and the associated front rolling means.

16. The mobile lift as defined in claim 1 in which said steering mechanism is connected for steering both of said front rolling supports and said back rolling supports.

17. The mobile lift as defined in claim 1 in which said steering mechanism is connected for at least one of independent steering and synchronized steering of said rolling supports.

18. The mobile lift as defined in claim 1 in which said telescoping members of said frame structure include end members that are connected together, and center members slidably connected to associated end members whereby center members of selected lengths are substitutable for selectively increasing and decreasing the overall size of the frame structure.

19. The mobile lift as defined in claim 1 in which said vertical telescoping frame members comprise one of (i) a first telescoping stage, and (ii) first and second telescoping stages for increased height adjustability of the frame structure.

20. The mobile lift as defined in claim 1 is which the telescoping members of the horizontal frame structure are positioned proximate the perimeter thereof such that the center of the horizontal frame structure is generally open and through which a load may extend.

21. The mobile lift as defined in claim 1 further comprising actuators connected for powered raising and lowering of the frame structure.

22. The mobile lift as defined in claim 21 in which said actuators comprise independently operable front and back actuators for independently raising and lowering the front and back of the frame structure.

23. The mobile lift as defined in claim 1 further comprising actuators connected for powered increasing and decreasing the length of the frame structure.

24. The mobile lift as defined in claim 1 further comprising power units to supply power requirements of the lift, said power units being located connected to the frame structure for raising and lowering therewith.

25. The mobile lift as defined in claim 1 further comprising bottom stabilizer leveling pads connected in fixed relation to said vertical frame members proximate the four corners of the lift, said pads being hydraulically powered between an upper position with the rolling supports on the ground and a lower position raising the rolling supports from the ground.

26. The mobile lift as defined in claim 1 in which the article lift apparatus is connected in fixed relation to the frame structure for raising and lowering the load therewith.

27. The mobile lift as defined in claim 1 in which the article lift apparatus is operable to raise and lower the load independently of movement of the frame structure.

28. The mobile lift as defined in claim 1 in which the article lift apparatus is operable to independently move the load forwardly, rearwardly, and sideways.

29. The mobile lift as defined in claim 1 in which said telescoping members are provided with position-locking means to over-ride the telescoping operation thereof.

30. The mobile lift as defined in claim 1 further comprising a platform structure connected for raising and lowering with the frame structure.

31. The mobile lift as defined in claim 1 further comprising a mechanical lift mechanism connected for raising and lowering with the frame structure.

32. The mobile lift as defined in claim 1 further comprising a portable loading and unloading dock movable therewith.

33. The mobile lift as defined in claim 1 further comprising a pair of laterally spaced forks connected for raising and lowering with the frame structure.
